(19) United States
(12) Patent Application Publication
(10) Pub. No.: US 2011/0024615 A1
(43) Pub. Date: Feb. 3, 2011

(54) CELL INJECTOR FOR FLOW CYTOMETER HAVING MASS SPECTROMETER DETECTOR AND METHOD FOR USING SAME

(76) Inventors: Scott D. Tanner, Aurora (CA); Dmitry R. Bandura, Aurora (CA); Vladimir I. Baranov, Richmond Hill (CA)

Correspondence Address: OGILVY RENAULT LLP, 1, Place Ville Marie, SUITE 2500, MONTREAL, QC, H3B 1R1, CA

(21) Appl. No.: 12/521,272

(22) PCT Filed: Dec. 28, 2007
(86) PCT No.: PCT/CA07/02374

§ 371 Date: Oct. 20, 2010

Related U.S. Application Data
(60) Provisional application No. 60/882,634, filed on Dec. 29, 2006.

(51) Int. Cl. B01D 59/44; H01J 49/26

(52) U.S. Cl. 250/282; 250/288

(57) ABSTRACT

A flow cytometer instrument and method for use thereof is described. The cell injector can receive particles from a sample slurry of particles associated with a biological material, and the cell injector can select particles from the sample slurry for injection into a mass spectrometer detector for the analysis of the individual particle. The spectrometer can have a plasma torch having a center tube being connected to the cell injector to receive the particles, a radio frequency power source and a load coil coupled to the plasma torch to generate and maintain a plasma in the plasma torch for ionizing the received particles, and a mass detector disposed downstream of the plasma torch for receiving ionized particles from the plasma torch and operative for detecting the particles in the sample slurry.

### CROSS-REFERENCE TO RELATED APPLICATION

This application claims the benefit of U.S. Provisional Patent Application Ser. No. 60/882,634, entitled “Cell Injector for Flow Cytometer Having Mass Spectrometer Detector and Method for Using Same” and filed Dec. 29, 2006, the entire contents of which are hereby incorporated by this reference.

### COPYRIGHT AND LEGAL NOTICES

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyrights whatsoever.

### FIELD OF THE INVENTION

The invention relates to the field of flow cytometers, and particularly to cytometers having a mass spectrometer detector and/or a cell injector.

### SUMMARY OF THE INVENTION

The invention relates to a flow cytometer having a mass spectrometer detector and methods relating to same^{1;2}.

In one aspect, the invention features a cell injector for a flow cytometer instrument with a mass spectrometer detector for the analysis of individual particles in a sample containing a slurry of particles associated with a biological material (“slurry sample”), said spectrometer comprising:
a plasma torch further comprising a center tube being connected to said cell injector to receive said particles;
a RF frequency power source and a load coil coupled to said plasma torch for coupling energy to generate and maintain a plasma further capable of ionizing said sample;
a mass detector disposed for receiving the ionized sample from said plasma torch and operative for detecting individual particles in the ionized sample.
   for which the cell injector is connected to receive particles from said slurry sample and provides particles in a form suitable for efficient analysis by said flow cytometer instrument with mass spectrometer detector

In another aspect, the invention features a flow cytometer instrument with a mass spectrometer detector for the analysis of individual particles in a sample containing a slurry of particles associated with a biological material (“slurry sample”), said spectrometer comprising:
an optical flow sorter connected to receive particles from the slurry sample;
a cell injector connected to an outlet of the optical flow sorter;
a plasma torch further comprising a center tube being connected to said cell injector to receive said particles;
a RF frequency power source and a load coil coupled to the plasma torch for coupling energy to generate and maintain a plasma further capable of ionizing the sample;
a mass detector disposed for receiving the ionized sample from the plasma torch and operative for detecting individual particles in the ionized sample.

In one embodiment, the cell injector comprises an optical flow cytometry particle sorter injector connected to receive particles from the slurry sample and which transports the particle-containing droplets produced by the sorter through an aperture or slit into a high speed argon stream to strip at least some of the solvent from the particles, and which said argon stream transports the solvent-stripped particles to an inductively coupled plasma for subsequent mass analysis.

In another embodiment cell injector further comprises a nebulizer to produce a spray in the form of a mist composed of droplets of the sample solution, particles, particles in the droplets, and vapors of said sample solution.

In another embodiment the cell injector further comprises a nebulizer to produce a spray in the form of a mist composed of droplets of the sample solution, particles, particles in said droplets, and vapors of said sample solution having an outlet connected to a reversed spray chamber disposed for receiving the spray and which classifies the droplets and particles in the spray according to their momenta and preferentially transmits droplets and particles having the largest momenta, and further comprising means of directing the classified particles to an inductively coupled plasma torch.

In another embodiment the cell injector is connected to receive particles after interrogation and spatial sorting of the slurry sample by an optical flow cytometry particle sorter injector whereby particles of interest as determined by at least one analytical characteristic are spatially separated from other particles.

In another embodiment the cell injector comprises a nebulizer for pneumatic nebulization of the slurry sample including at least one of coaxial continuous nebulization, cross-flow continuous nebulization, pulsed nebulization (either cross-flow or coaxial) or flow-focusing pneumatic nebulization by way of providing a nebulizing gas flow.

In another embodiment the cell injector further comprises one or more chargers for charging at least one of droplets, particles, or particles within droplets and one or more deflectors for electrically deflecting them, according to classification provided by the flow cytometry particle sorter injector based on at least one analytical characteristic.

In another embodiment the cell injector further comprises one or more chargers of charging the entire spray of droplets, particles, particles within droplets except at least some particles of interest as determined by classification provided by the flow cytometry particle sorter and one or more deflectors for electrically deflecting all of the unwanted spray components.

In another embodiment of the cell injector, the nebulizer operating conditions can be varied by changing the liquid and sample gas flow rates to vary the particle size and particle size distribution of the nebulized slurry containing sample.

In another embodiment the cell injector further comprises pneumatic or spinning-disk or ultrasonic agitation means of conversion of the slurry containing sample into droplets wherein each droplet contains either zero or at least one particle.

In yet another embodiment the cell injector is provided with a device for focusing at least some of droplets of the sample solution, particles or particles in said droplets, through an aperture through which said nebulizing gas is accelerated in a manner in which the shear forces of said nebulizing gas strip at least some of the solvent from the particles, after which the solvent-stripped particles are transported to an inductively couple plasma for subsequent elemental analysis.

In an aspect, there are devices and methods for transporting an aerosol having particles in droplets and droplets, which may be produced either by a flow sorter or by any other device or method of producing droplets including a nebulizer, to a second stage of pneumatic nebulization in which solvent is stripped from particles that are contained within droplets. In an alternate embodiment, the nebulizer can produce a stream of droplets within the flow of the nebulizer gas and in which the acceleration of the droplets and gas from the nebulizer through the aperture causes additional stripping of solvent from the particles. Thus, in this alternate embodiment, there is not a “second stage” of nebulization with a second nebulizing gas, but the first nebulizer gas acts in two capacities: in the first instance to produce droplets that may contain particles and then, through the action of acceleration through the aperture, causes additional stripping of solvent from the particles.

In another embodiment the cell injector cell injector in which the aperture is a critical flow orifice in which said nebulizing gas is accelerated to supersonic velocity.

In another embodiment the cell injector further provides a desolver to desolvate the spray of the slurry containing sample by a thermal device and/or employing a solvent-permeable membrane.

In another embodiment the analytical characteristic measured by the optical flow cytometry particle sorter injector includes at least one of light scattering or stimulated fluorescent emission.

In another embodiment the cell injector inlet is connected by a capillary tube to the flow cytometry particle sorter injector.

In another aspect the invention features a method of analysis of individual particles in a sample containing slurry of particles associated with a biological material employing a flow cytometer instrument with a mass spectrometer detector comprising the steps of:
nebulization to produce a spray in the form of a mist composed of droplets of the sample solution, particles, particles in the droplets, and vapors of the sample solution;
classification of the droplets and particles in the spray using at least one classification parameter;
introduction of the classified particles into the plasma torch;
detection of at least one element that was contained within or on the individual particles in the ionized sample solution.

In one embodiment the method includes the slurry sample being converted to droplets, and each droplet contains either zero or at least one particle, and the particle is provided by the flow cytometry particle sorter injector.

In another embodiment said method includes the solvent being partially or completely separated from the particle so that the particle is introduced into the plasma torch with a concomitantly reduced solvent load.

In another embodiment the method includes nebulizing the slurry sample by the cell injector wherein the cell injector produces an aerosol at a liquid flow rate which extends from less than 1 micro l/min up to 1000 micro l/min.

In another embodiment the method includes nebulizing the slurry sample by the cell injector wherein the nebulizing gas flow rate is between 0.1 liters/min. and 1.5 liters/min.

In another embodiment said method includes wherein said particles are at least one of cells, bacteria, viruses, pollen, chromosomes, particles associated with biological molecules (such as proteins or oligonucleotides).

In another embodiment said method includes wherein the slurry containing sample is further diluted with a solvent having a high vapor pressure or with a supercritical fluid.

In yet another embodiment the method includes the high vapor pressure solvent being methanol or ethanol.

In another aspect of the invention there is a flow cytometer instrument, comprising a cell injector for receiving particles from a sample slurry of particles associated with a biological material, the cell injector transforming the sample slurry of the particles into a form suitable for ionization and transmitting the transformed particles for injection into a mass spectrometer detector for the analysis of the individual particle, the spectrometer having a plasma torch having a center tube being connected to the cell injector to receive the particles, a radio frequency power source and a load coil coupled to the plasma torch to generate and maintain a plasma in the plasma torch for ionizing the received particles, and a mass detector disposed downstream of the plasma torch for receiving ionized particles from the plasma torch and operative for detecting the particles in the sample slurry. The flow cytometer instrument of may further comprise an optical flow sorter connected upstream of the cell injector.

In another aspect of the invention there is a flow cytometer instrument for the analysis of individual particles in a sample slurry of particles associated with a biological material, the instrument comprising an optical flow sorter receiving particles of the sample slurry, a cell injector connected to an outlet of the optical flow sorter to select particles from the slurry, a plasma torch having a center tube being connected to the cell injector to receive the particles, a radio frequency power source and a load coil coupled to the plasma torch for generating and maintain a plasma in the torch capable of ionizing the particles, and a mass detector disposed downstream of the plasma torch for receiving the ionized particles from the plasma torch and operative for detecting individual particles in the sample slurry.

The sample slurry may include at least one of a solvent or buffer solution and the flow sorter may receive droplets containing the particles from the sample slurry and transport the droplets through an aperture into a high-speed gas stream, through which an amount of the at least one of the solvent or buffer solution is stripped from the droplets containing the particles, and such particles are provided to the plasma torch for vaporization, atomization and ionization. The high-speed gas stream may be a high-speed argon gas stream.

The flow cytometer instrument may further comprise a nebulizer connected to the sorter, the nebulizer producing the droplets containing the particles in a spray in the form of a mist, wherein the droplets are smaller than those produced by the flow sorter, for injection into the plasma torch. The nebulizer may include an outlet connected to a reversed spray chamber disposed for receiving the spray, the spray chamber operative to classify the droplets of particles in the spray according to their momenta.

The nebulizer may operate by pneumatic nebulization of the sample slurry for producing the droplets containing particles. Pneumatic nebulization may include providing a nebulizing gas flow utilizing at least one of coaxial continuous nebulization, cross-flow continuous nebulization, cross-flow pulsed nebulization, coaxial pulsed nebulization, and flow-focusing pneumatic nebulization. The nebulizer may convert the sample slurry to the droplets by at least one of pneumatic, spinning-disk, and ultrasonic agitation operation. The operation conditions of the nebulizer may be variable by changing an input flow rate of the sample slurry and a flow rate of the nebulizing gas, whereby droplet size and droplet size distribution of the resultant spray of sample slurry is affected.

The spray chamber may selectively transmit droplets containing the particles to the plasma torch on the basis of their momenta. The droplets containing the particles may be subjected to interrogation and spatial sorting by the optical flow sorter, and droplets containing the particles of interest as determined by at least one analytical characteristic may be spatially separated from other droplets. The analytical characteristic may include at least one of light scattering or stimulated fluorescent emission.

The flow sorter may further comprise a charger for charging at least a portion of the droplets containing the particles and a deflector for deflecting the portion of charged droplets containing the particles, wherein the charging and deflecting is controlled according to a classification provided by the sorter based on at least one analytical characteristic. The classification may determine the portion of the droplets that relate to unwanted spray components, so that the charger charges such unwanted spray components and the deflector deflects such components away from entry to the cell injector.

The flow cytometer instrument may further comprise an aperture through which the nebulizing gas is accelerated in a manner in which shear forces of the nebulizing gas strip at least some of the buffer solution from the particles. The aperture may be a critical flow orifice through which the nebulizing gas is accelerated to supersonic velocity. The flow cytometer instrument may further comprise a desolvator to desolvate the spray of the sample slurry by way of at least one of a thermal device or a solvent-permeable membrane. The flow sorter may be connected to the cell injector by a capillary tube.

The spray may be produced at a sample slurry flow rate that extends from approximately 1 micro l/min to 1000 micro l/min. The nebulizing gas flow rate may be between 0.1 liters/min. and 1.5 liters/min. The particles may be at least one of cells, bacteria, viruses, pollen, chromosomes, or particles associated with biological molecules, including proteins or oligonucleotides. The at least one of a solvent or a buffer solution includes at least one of a high vapor pressure fluid or a supercritical fluid. The high vapor pressure fluid includes at least one of methanol or ethanol.

In another aspect of the invention there is a method of analyzing particles in a sample slurry associated with a biological material using a flow cytometer instrument with a mass spectrometer detector, the method comprising nebulizing the sample slurry to produce a spray in the form of a mist, the spray having droplets at least some of which contain particles from the sample slurry, classifying the droplets in the spray by spatially separating the droplets according to their momenta, introducing a selected portion of the classified droplets into a plasma torch of the instrument to ionize the droplets and detecting at least one element that was at least one of contained within or on the particles that were in the droplets.

The sample slurry may include a solvent or buffer solution, and prior to introducing the classified droplets into the plasma torch, at least a portion of the solvent of buffer solution may be separated from the droplets of particles, whereby the droplets are introduced into the plasma torch with a concomitantly reduced solvent or buffer solution load. The spray may be produced at a sample slurry flow rate that extends from approximately 1 micro l/min to 1000 micro l/min. The particles may be at least one of cells, bacteria, viruses, pollen, chromosomes, or particles associated with biological molecules, including proteins or oligonucleotides. The at least one of the solvent or buffer solution may include at least one of a high vapor pressure fluid or a supercritical fluid. The high vapor pressure fluid may include at least one of methanol or ethanol.

### BRIEF DESCRIPTION OF THE FIGURES

The invention is illustrated in the figures of the accompanying drawings, which are meant to be exemplary and not limiting, and in which like references are intended to refer to like or corresponding parts.

FIG. 1 is a schematic of one embodiment of a Flow Cytometer Analyzer.

FIG. 2 is a schematic of one embodiment of a Fluorescence Activated Flow Sorter (FACS).

FIG. 3 is a schematic of one embodiment of an Inductively Coupled Plasma Mass Spectrometer (ICP-MS).

FIG. 4 is schematic of one embodiment of a Flow Cytometer having a Mass Spectrometer detector and including a cell injector.

FIG. 5 is schematic of one embodiment of a cell injector which is additionally utilizes flow through reversed spray chamber.

FIG. 6 is schematic of one embodiment of a cell injector using a cyclonic reversed spray chamber.

FIG. 7 is schematic of one embodiment of a cyclonic reversed spray chamber.

FIG. 8 is schematic of one embodiment of a flow through reversed spray chamber.

FIG. 9 is representation of experimental results of injection of 1.8 micro m polystyrene beads doped with metals and KG1a cells stained with Ir-intercalator employing a cell injector.

FIG. 10 is a schematic of an embodiment of an Inductively Coupled Plasma Mass Spectrometer (ICP-MS).

### DETAILED DESCRIPTION OF EMBODIMENTS

Embodiments of methods, systems, and apparatus according to the invention are described through reference to the Figures.

The description which follows, and the embodiments described therein, are provided by way of illustration of an example, or examples, of particular embodiments of the principles of the present invention. These examples are provided for the purposes of explanation, and not limitation, of those principles and of the invention. In the description, which follows, like parts are marked throughout the specification and the drawings with the same respective reference numerals.

Flow cytometry is a method of determining proteins, genes or oligonucleotides in whole single cells or single particles by measurement of light scattering and by stimulated fluorescent emission from fluorophores attached to antibodies that specifically bind to the proteins, genes or oligonucleotides of interest. A typical challenge of flow cytometry is to distinguish droplets containing single cells or particles from droplets containing multiple cells or particles, from droplets absent of cells and particles and from droplets containing cell or particle fragments.

In one aspect, the invention provides a flow cytometer instrument with a mass spectrometer detector that measures the elemental composition of a cell or particle, specifically elements that are attached to antibodies or other affinity reagents instead of typical fluorescent tagging.

One challenge typically encountered in using mass spectrometers coupled to Inductively Coupled Plasma (ICP) ionization sources is that the ICP may be liable to quenching or cooling if the solvent load associated with a cell in a droplet is too large for the plasma to efficiently vaporize, atomize and ionize the cell^{3;4}. Therefore one aspect the invention provides a device and method to strip solvent from the cell prior to introduction to the ICP. A further aspect of the invention spatially resolves the solvent and its associated salts from the cell or particle under investigation, so that the elemental composition of the cell or particle itself can be measured.

The characteristic sample state before direct introduction into ICP ionization source is a suspension of solid or liquid particles in a gaseous medium. The conventional ICP-MS instrument incorporates a sample introduction system typically consisting of means of converting sample to an aerosol (for example: pneumatic nebulizer—converts a liquid sample in the form of a fine spray that is introduced in ICP source through a spray chamber^{5;6}). The spray chamber is a passive flow through device which separates or classifies the suspension of solid or liquid particles according to particle momenta, which for an aerosol is usually related to particle sizes. It is well known for a person proficient in the art of the Elemental Analysis employing ICP-MS that the ICP ionization source works with the highest efficiency in a narrow particle size distribution range typically below several micrometeres^{4;7}. Therefore, a spray chamber can be configured to classify large particles from the suspension for rejection and provides means to dispose unwanted portions of the spray. An exemplary classification can be accomplished by causing the aerosol spray to curve under the influence of the gas flow (for example, a Scott-type spray chamber or a cyclonic spray chamber), so that particles having larger momenta (particle size) are caused to deposit on the walls of the spray chamber and particles having smaller momenta (particle size) are transported with the gas to the exit of the spray chamber. Accordingly, particles of smaller momenta (size) are transmitted from the spray chamber to the ICP.

The flow cytometer instrument with a mass spectrometer detector is an instrument that allows the analysis of individual particles, such as cells or beads, introduced into the ICP ionization source as a suspension in a gaseous medium. Therefore, a conventional ICP-MS sample introduction system cannot be used because it is specifically designed to prevent particles such as cells or beads from the suspension to reach the ICP source and dispose them to waste, unless the particles are within the range of the sample introduction system⁸⁻¹².

Therefore, there is a need for a novel sample introduction system for particulate matter such as cells or beads—a cell injector. The foregoing and other aspects of the invention are not limited specifically to the cell injection and incorporate any particulate matter which will become more apparent from the following description of specific embodiments.

In one aspect, the invention provides the sample introduction system for flow cytometer instrument with a mass spectrometer detector which functionality is counter-intuitive to a conventional ICP ionization source sample introduction system. In one embodiment the invention describes the cell injector further comprising a spray chamber that in one aspect can be called the reversed spray chamber. The reversed spray chamber is disposed for receiving the spray, classifying the droplets and particles in the spray, and directing the classified particles to an inductively coupled plasma torch. Contrary to the conventional spray chamber described earlier, this aspect of the invention tends to transmit particles having larger momenta (particle size). In an embodiment, this is performed by aligning the exit of the spray chamber with the outer edge of the gas flow swirl, which is enriched in particles having larger momenta (particle size), while the inner portion of the gas flow swirl, which is enriched in particles having smaller momenta (particle size) is discarded. Alternatively, the exit of the spray chamber may be aligned with the axis of the nebulization gas flow, which is enriched in particles having larger momenta (particle size) while the outer region of the nebulizer gas flow, which is enriched in particles having smaller momenta (particle size) is discarded. In this aspect the invention provides vaporization, atomization and ionization of larger particulate matter which would be rejected and wasted in a conventional sample introduction system.

A conventional flow cytometer is an instrument that allows the analysis of individual particles, such as cells or beads. Use of a cytometer can advantageously include the dispersal of particles within a fluid, usually a buffer solution. Most often, the fluid stream is interrogated, for example by a laser, and the forward and side scatter of the light informs when a particle passes the interrogation region and also informs on the size and granularity of the particle. Other characteristics of the particle may also be determined, for example by the presence and/or quantity of one or more of a protein, antigen, gene, oligonucleotide or other biomarker that has been tagged, for example, by a fluorophore. A multitude of such scattering and biomarker signals can be used to distinguish a particular particle, such as a diseased cell, from a complex matrix of other particles, such as a blood sample.

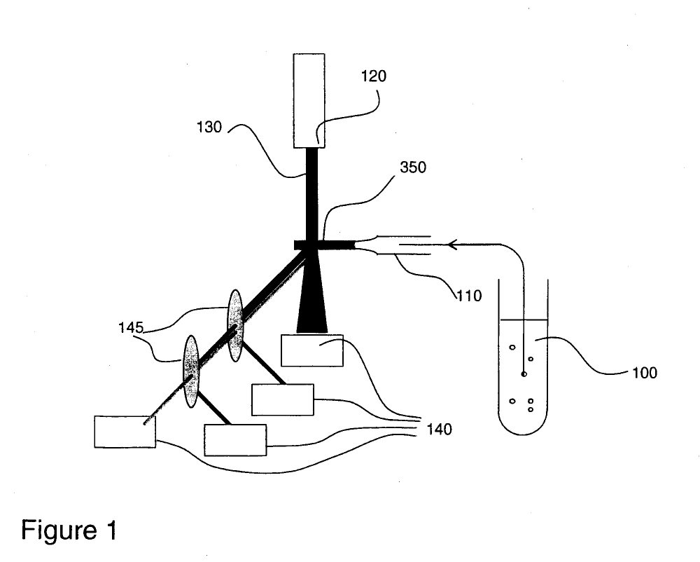

A flow cytometer configured in one embodiment of a multi-channel analyzer device is shown in FIG. 1. The sample 100 which can be, but is not limited to, a suspension of cells or other particles in a liquid, is introduced into the nozzle 110 from which a liquid jet 350 is formed as known in the art of flow cytometry. The jet 350 can be illuminated by the laser 120. The light emitted from the laser or induced to be emitted from the sample can be detected by one or more detectors 140. The light detected by detector(s) 140 provides information on the presence and/or properties of a cell or a particle in the jet 350. Such light may be forward scattered or side scattered laser light, or may be fluorescence stimulated by the laser 120 from fluorophores that are attached to antibodies which are bound to antigens of interest in or on the cells or particles. In the instance that more than one wavelength is to be detected, dichroic filters 145 or bandpass filters are used to filter the light into the wavelengths that are specific to given cell or particle characteristics (e.g., different fluorophore emission wavelengths). There are many known variations on this general concept, including different means of preparing the sample for laser illumination, multiple laser excitation and delayed excitation and emission, and different emitters including quantum dots and fluorescent proteins, and different light detectors (often photomultiplier tubes); all are similar in using light as indicative of the presence, size and granularity of a cell or particle and as indicative of the presence of antigens of interest either directly (e.g., fluorescent proteins) or indirectly (e.g., fluorescent-tagged antibodies specific to the antigens).

Fluorescence-based flow cytometry is capable of multiplexed operation (detecting more than one antigen through the use of distinguishable fluorophores attached to different antibodies against different antigens), but cytometry is fundamentally limited by the overlap of the emission spectra of the fluorophores, so that complex compensation (or signal correction) is required in the instance that one fluorophore emits to yield a signal at the same wavelength that is used for detection of another fluorophore. This limitation tends to restrict the cytometry to a few, often 4, sometimes as many as 16 with heroic efforts in sample and instrument preparation and compensation in multiplexed operation.

One form of the cytometer, known as the Fluorescence Activated Cell Sorter, FACS, is capable of purifying particle populations on the basis of the signals obtained. Typically, droplets of the fluid stream are produced, often by piezoelectric means. Such droplets are typically of the order of 100 micron diameter, containing approximately 0.5 mL of solution including the particle, if present. In various configurations the particle is interrogated before, during and/or after droplet production. Some or all of the droplets are charged, and droplets that satisfy a predetermined criterion (for example, light scatter signal and/or a combination of fluorescent signals) are diverted from the remainder droplets to be collected as a purified fraction.

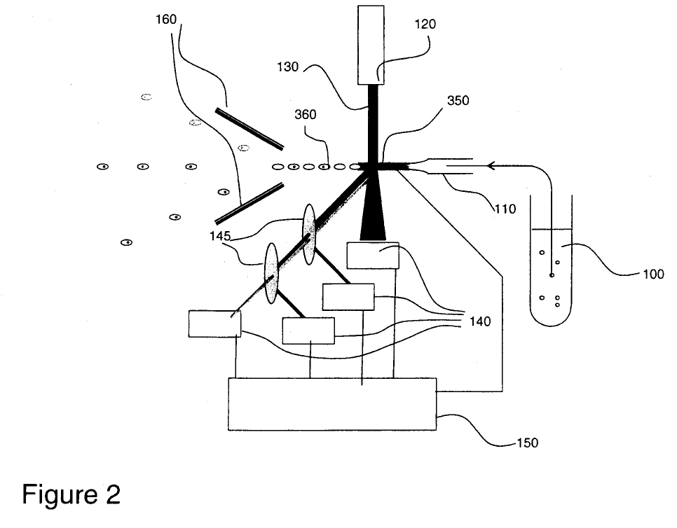

One embodiment of a Fluorescence Activated Flow Sorter, based on the scheme of the analyzer shown in FIG. 1, is shown in FIG. 2. Chargers 150 are provided to charge the liquid jet 350 at least some of the time. The liquid jet is broken into a stream of droplets 360 by for example means known in the art, for example, by a perturbation of the liquid jet 350. At least some of the droplets are thereby caused to carry an electrical charge, and at least some of the droplets remain neutral. Deflectors 160 are provided that selectively deflect at least some of the droplets; as shown in FIG. 2, and one type of deflecting the charged droplets is the application of an electrostatic field through oppositely charged plates. Various other ways of charging and deflecting droplets may also be used. The decision on whether or not to charge the jet 350 in such a manner that a specific subsequent droplet will be charged, or to otherwise charge a droplet, can be made on the basis of the signals obtained at the detector(s) 140. For example, if the signals are such that a predefined condition is met (for example, that indicate that certain antigens or cell properties are satisfied) the jet may be charged (or made to be neutral) in such a manner that the droplet that contains that cell or particle will be deflected by a pre-determinable amount in the deflection device 160. The FACS instrument may be used, for example, to purify cell populations by collecting the streams of cells having different degrees of divergence in deflection device 160.

One particularly successful approach to flow cytometry has included the use of biomarkers identified using fluorescently-labeled antibodies. The variety of available fluorophores provides an opportunity for multiplex analysis of high order. A principal limitation in this respect results from mismatched excitation spectra and overlap of emission spectra that results in a practical restriction in the number of detection channels and the accessible dynamic range.

The following description provides significant simplifications of a complex field to assist in its understanding, and one of skill in this art will appreciate that such simplifications do not trivialize the excellent science and exquisite technologies that have been developed. Despite such simplifications, one of skill in this art will be able to understand and practice the invention described herein after realizing the description in view of his or her knowledge of the art.

In one aspect, the invention provides a method of massively multiplexed immunoassay, which approach is well suited for application to flow cytometry. The method includes the use of tags (or labels) comprising elements (as opposed to fluorophores) that are analyzed by elemental analytical techniques. One technique that provides potential for multivariate assay of high order is elemental mass spectrometry, and specifically, Inductively Coupled Plasma Mass Spectrometry (ICP-MS). This method of elemental analysis has been available and continuously improved since its original description¹³. The method utilizes a finely dispersed particulate distribution of sample, typically an aerosol of preferably less than 10 micron diameter or a plume of solid particles of preferably less than 1 micron diameter. The sample is injected into the central channel of the ICP whereupon it is rapidly and sequentially vaporized, atomized and ionized, and thereafter a sample of the plasma is extracted into the mass spectrometer and the elemental composition of that fraction is determined. The preferred diameters of aerosol and solid particles noted above can be selected as the upper limits to the size of particle to be completely vaporized in the plasma. For some embodiments using larger particles, such larger particles may tend to be incompletely consumed, resulting in incomplete elemental information in the instance of fractionation, and/or deleterious effects such as clogging or surface contamination resulting in signal drift from deposition of any incompletely vaporized particles. Such larger particles are thus generally not preferred.

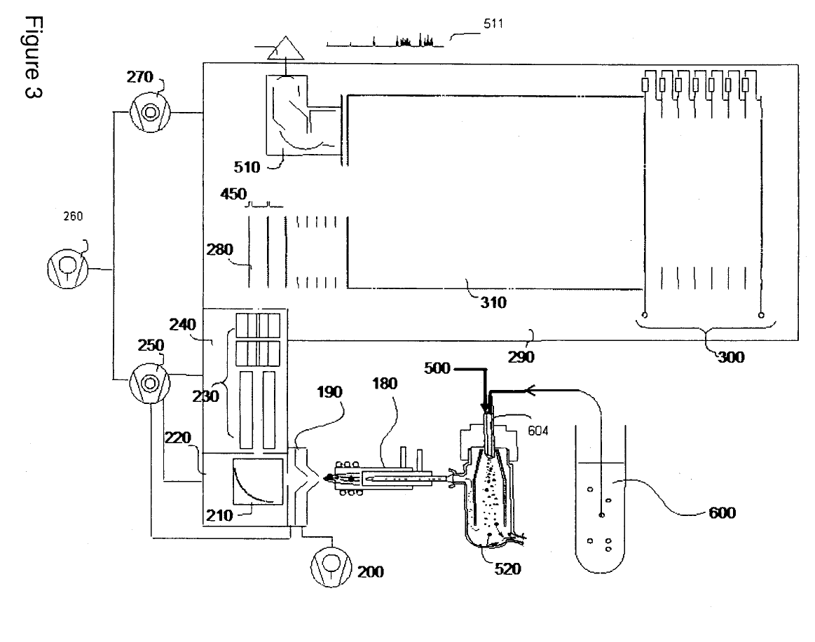

Various configurations of ICP-MS instruments are known in the art. One configuration which is specifically designed and invented for the present flow cytometry application is shown in FIG. 3. In the embodiment shown in FIG. 3, a sample is introduced by pneumatic nebulization, though other means are known in the art that may be used (e.g., laser ablation particulate injection and direct particulate injection^{3;8;11}). The sample 600, which is usually a liquid but may also be slurry, is introduced via a pneumatic nebulizer 604 together with a nebulization gas 500, by which means the liquid sample is converted to an aerosol. The aerosol is size-separated in spray chamber 520 (a Scott double pass spray chamber is shown; there are many variations of spray chambers that may be used) so that, for example, aerosol particles having smaller diameters (typically less than 10 microns) can be passed further into the ICP torch 180 while larger aerosol particles are diverted to another destination, such as waste. The aerosol particles that are transmitted into the ICP torch 180 can then be atomized and ionized in the torch 180, according for example to methods known in the art of ICP-MS. The ionized material from the aerosol particles can then be introduced via vacuum interface 190, operated at a reduced pressure achieved via vacuum pumps 200 and 250, into the vacuum chamber 220. The ions may be deflected via deflection device 210 into the vacuum chamber 240, where ion optical device 230 further transport at least some of the ions into the vacuum chamber 290 of a time-of-flight (TOF) mass analyzer, in particular, into the push-out region 280 to which electrical pulses 450 can be applied in such a way that at least some of the ions are deflected side-wise towards the field-free region 310 and ion mirror 300. At least some of the ions may then be reflected by the ion mirror 300 back into the field-free region 310 and then strike the detector 510. The detector 510 can convert ion current into an electrical waveform which may then be amplified by an amplifier and digitized by digitizer (not shown). As known in the art of TOF Mass Spectrometry, the abundance and mass-to-charge ratios of ions pushed-out from the region 280 can be easily determined, thus the chemical composition of the aerosol particles introduced into the ICP torch 180 can also be determined. Vacuum pumps 250, 260 and 270 are shown that provide reduced pressure in the chambers 210,240, 290 which is useful for operation of the described instrument.

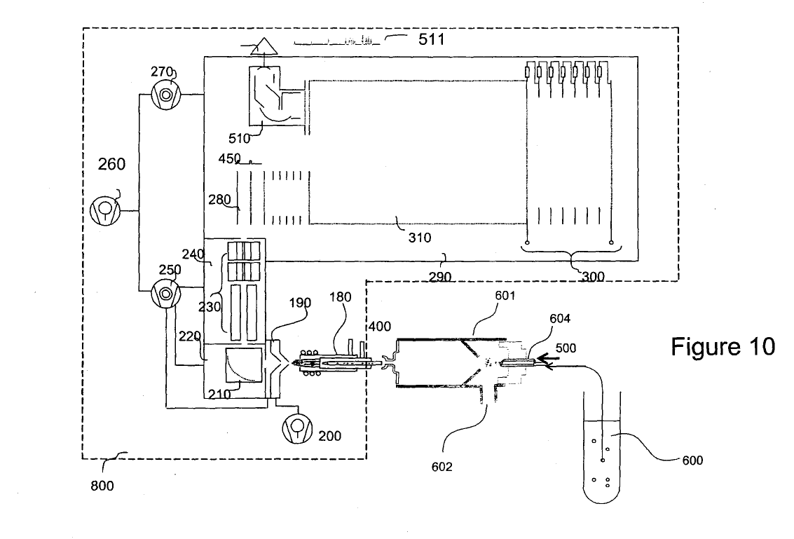

A further configuration of an ICP-MS instrument which is specifically designed and invented for the present flow cytometry application is shown in FIG. 10. In the embodiment shown in FIG. 10, a sample 600, which is usually a liquid but may also be slurry, is introduced via a pneumatic nebulizer 604 together with a nebulization gas 500, by which means the liquid sample is converted to an aerosol, which may then be introduced to a reversed spray chamber 601 and then transmitted to torch 180, optionally as particles. The embodiment shown in FIG. 10 may thereafter may operate in substantially similar fashion, or contain substantially similar elements, as the embodiment shown in other Figures, such as FIG. 3.

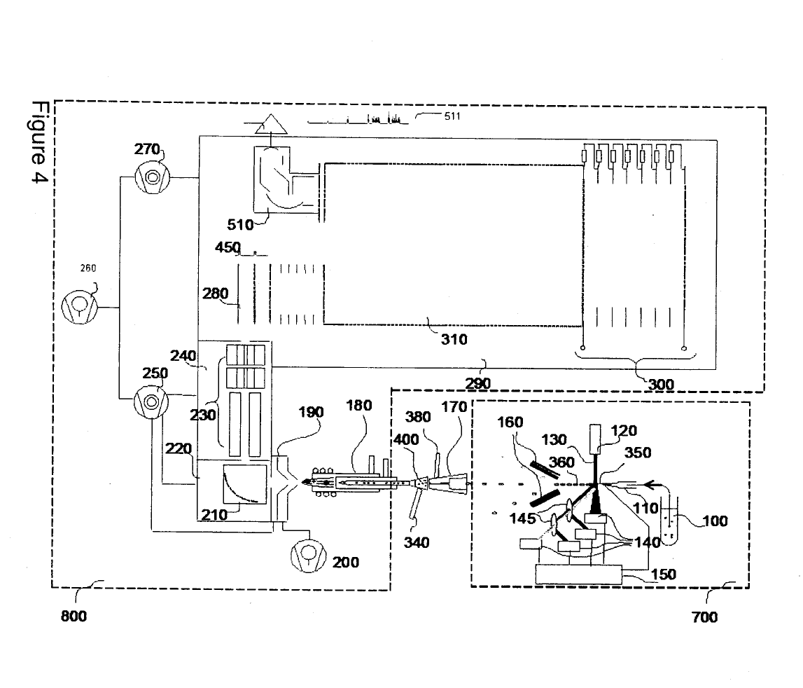

One configuration of a flow cytometer having a mass spectrometer detector and incorporating a cell injector in accordance with an aspect the invention is shown in FIG. 4. This configuration is particularly well adapted for application to flow cytometry. Droplets derived from the sample 100 that contain cells or particles that are wanted for analysis, according to the information collected by the detector(s) 140, and which are directed (note that this may include no deflection, for example for droplets that are not charged) by deflection device 160 are further transferred to the cell injector 170, which can remove at least some of the solvent from the droplets so that the droplets 400 that contain cells and particles to be analyzed are associated with less solvent than droplets from the stream 360. The injector 170 may for example employ pneumatic nebulization for removing the solvent, with gas introduced via conduit 380. In another embodiment, spinning disk nebulization can be used for the purpose of removing the solvent and producing droplets 400 that contain cells or particles that are associated with less solvent than the original droplets from the droplet stream 360. In yet another embodiment, droplets 400 may be formed from the original droplets from the stream 360, in the instance that they are charged, due to coulombic forces that may break the original droplets into smaller ones by a process known in the art of electrospray.

A further embodiment may include device 340 to introduce a make-up gas that carries droplets 400 into the inductively coupled plasma torch 180. Preferably, the size of the droplets 400 that are introduced into the torch 180 is not greater than a particular maximum size which may be efficiently vaporized and ionized by the inductively coupled plasma. In many cases, for the torch 180 operated in the conventional ICP-MS manner, this maximum size is on the order of 10 micrometers. In other cases, when higher than usual power is applied to the torch 180, the maximum tolerable size can be larger than 10 micrometers. The droplets 400 are vaporized, and the material which the droplets 400 contain, is atomized and ionized in the torch 180, and is further subjected to mass analysis in the manner described above for FIG. 3.

Cell Injector 170 according to an embodiment of the present invention is shown acting as an interface between flow apparatus 700 and atomic spectrometry apparatus 800. However, the Cell Injector 170 that serves the specified purposes of the separation of associated cells or particles, removal of the solvent and salts from the surface of the cell or particle, and rupturing of the cell, may be achieved in combination with other Flow apparatus and Atomic Spectrometry apparatus not described or shown here, but such embodiments are included within the scope of the invention.

The high resolution of the detection (mass) channels of the ICP-MS, in combination with elements as tags (rather than fluorophores) alleviates the above-described limitation on the number of antigens that can be determined simultaneously. Accordingly, a flow cytometer with an ICP-MS detector, or described herein offers the capability for a very high degree of multiplex analysis, and the present invention can tend to enable preparation of the sample in a form that the ICP-MS can efficiently analyse, and provide an advance in analytical capability.

In some embodiments, the invention provides methods of, and apparatus for, subjecting a suspension of cells or particles in a solution to nebulization (also known as atomization) in such manner as to provide for (i) the separation of associated cells or particles (ii) to remove solvent and associated salts from the surface of the cell or particle, and/or (iii) to rupture the cell. The conditions of nebulization can be adjusted to selectively rupture the cell membrane of none, some or all of the cells so as to provide a means of distinguishing cells having more rugged cell membranes from cells having less rugged cell membranes. The conditions of nebulization can also be adjusted to affect the removal of the solvent shell surrounding the cell. The method and apparatus allow for the suspension of single cells or particles without substantial external buffer solution in a gas for study or analysis. Adjustment of the nebulizer flow rate and/or cross-sectional area of the nebulizer gas exit (nebulizer conditions), providing for variation of the velocity of the nebulizing gas, concomitantly provide for the suspension of whole cells having more rugged cell membranes in a gas and therefore distinguishing these cells from cells having less rugged cell membranes.

Nebulization or atomization may be accomplished by pneumatic devices, including concentric, cross-flow, flow-focusing or pulsed flow pneumatic nebulization, or by ultrasonic nebulization or by spinning-disk atomization, or by any other means consistent with the purposes disclosed herein. Some suitable devices and methods for nebulization are already known in the art.

Methods according to the invention can further provide for the pneumatic lysing of cells. In some instances, for example with very large cells, there may be an advantage to lysing the cells at a location close to the injector of the ICP so as to temporally spread the load on the ICP. The total transient mass spectrometer signal derived from the cell fragments can be measured and integrated to reflect the cell composition, including elemental tags. In the instance of large cells, a further benefit of lysing the cells is that the intracellular fluid could be selectively removed, for instance by membrane desolvation downstream of the cell injector 170 and upstream of the ICP torch 180, leaving the solids having elemental tags in the flow stream for analysis. Alternatively, as discussed herein, there may be an advantage to selectively lysing certain cells, particularly in a complex matrix where cells that are desired to be analyzed are not lysed: in some instances, the rigidity of the cell membrane may be a sufficient determinant and the sheer stress of pneumatic force can be adjusted to distinguish cells on this basis. Thus cells can be nebulized using different nebulizer configurations and conditions of nebulization.

Other embodiments according to the invention allow for the stripping of buffer solvents and their associated salts from cells or particles that are contained in a droplet suspended in a gas or carried in a gas stream.

Pneumatic stripping of the solvent shell tends to offer an advantage over thermal or other evaporation of the solvent because it spatially removes the salt content of the buffer solution from the cell or particle. This allows, for example, study or analysis of the cell in the absence of the buffer salts. This can be important where, for example, the salt or elemental content of the cell or particle itself is to be determined, or where the salt or elemental content of the cell or particle, or effects derived therefrom, is used as a trigger for the analysis of the cell or particle, and where the presence of buffer salts might confound the activation of the trigger. In contrast, thermal or other means of evaporation of the solvent from the cell or particle leaves a residue of the salts of the solution on the surface of the cell or particle, whereby analysis of the salt-encrusted cell or particle may lead to incorrect determination of the salt or element content of the cell or particle itself or may confound the use of the salt or element content as a trigger, and/or may make it difficult to distinguish the cell or particle from surrounding solvent vapour or aerosol.

In further embodiments the invention allows for subjecting a droplet or aerosol containing one or more cells, suspended in a gas or attached to a surface, to high frequency (e.g., ultrasonic) agitation so as to provide the benefits of pneumatic nebulization as described above.

Further embodiments allow for desolvation of a droplet or aerosol in a desolver that contains one or more cells by thermal and/or solvent gradient means (e.g., a permeable membrane) so as to achieve some of the benefits of pneumatic nebulization described above. Such methods can tend to concentrate the salts of the solution on the surface of the cell, and depending on conditions may cause the cell to shrink and/or otherwise modify due to osmosis or transfer of the liquid within the cell through the cell membrane. The construction and operation of desolvation devices are known in the field of ICP-MS.

Further embodiments provide stripping of at least some of the solvent from a cell or particle in a droplet in a first stage using pneumatic, ultrasonic, spinning disk, or other similar device, and a second stage whereby the remaining solvent (or a portion thereof) is removed from the cell or particle by complementary means including pneumatics, evaporation and/or gradient transport (such as membrane desolvation).

Further embodiments provide for removal of the solvent vapors from the gas stream containing cells or particles by way of condensation and/or solvent permeable membrane.

Further embodiments provide for entrainment of the cell or particle, from which the solvent has been stripped, in a stream of gas for transfer to a device for study or analysis (for example, in a stream of approximately 1 L/minute of Argon that is injected into an ICP).

In such embodiments it is possible to pre-select the aerosol, drop, cell or particle on the basis of an analytical characteristic (such as light scattering or stimulated fluorescent emission of a specific marker). This can be done within the capillary tube of an ICP leading to the pneumatic nebulizer. This may be an instance where pulsed nebulization has an advantage, and the pulse of nebulizing gas is triggered by detection of marker signal. Alternatively, the measurement of the pre-selection characteristic might be performed (i) before, during or after the conversion of slurry solution to droplets that may contain cells or particles and (ii) prior to solvent stripping, whereby the pre-selection characteristic is used to decide whether or not to subject the droplet to solvent stripping and/or subsequent elemental analysis.

It is also possible, in implementing processes according to the invention, to take advantage of the particle size distribution as a function of angle relative to the gas flow to enrich a fraction that contains cells as opposed to solvent-only particles or cell fragments. The inventors have noted that pneumatic nebulization can be configured to provide nearly exclusively aerosols of diameter less than about 20 microns, whereas the cells of interest may be greater than 30 micron diameter (and as much as 100 microns are larger). One configuration takes advantage of this differentiation. Those skilled in the relevant arts will appreciate that the cells can survive the nebulization because of the resilience of their cell membranes.

Means provided by the invention for pneumatic nebulization of slurries containing cells or particles can include: coaxial continuous nebulization, cross-flow continuous nebulization, pulsed nebulization (either cross-flow or coaxial) or flow-focusing pneumatic nebulization, or other devices or methods compatible with the purposes described herein. One preferred configuration is to adapt a conventional flow cytometry piezo-electric or other similar cell sorter injector with a desolvator. Entrainment in an argon stream for introduction to the ICP could be inhalation through an aperture or a slit into a high speed argon stream, or could involve coaxial entrainment. Entrainment can also involve charging the cell and electrically deflecting it, or conversely charging all of the aerosol except the cell of interest and deflecting all of the unwanted components.

In some embodiments, a suspension of cells can be converted to droplets wherein each droplet contains no cells or one cell, and the solvent associated with the droplet is stripped from the cell, if present. In such embodiments, the solvent can be stripped from the cell by pneumatic or spinning-disk. In an alternate embodiment, the solvent is stripped from the cell by way of agitation, an example of which is ultrasonic agitation of the droplet. In further embodiments, the solvent can be partially or completely separated from the cell so that the cell is introduced into the ICP with a concomitantly reduced solvent load.

In further embodiments, methods according to the invention provide droplets that may contain cells or particles using devices and methods known in flow cytometry, pre-selection of droplets containing cells or particles as described earlier, and capture of the pre-selected cells or particles in, for example, a capillary tube of the FCI. The captured droplets can then be transported to a pneumatic stripping of buffer solvent as described earlier, and the solvent-stripped cells are transported for subsequent elemental analysis.

In further embodiments, droplets that may contain cells or particles in flow cytometry, and pre-selected as described earlier, are focused through an aperture through which gas is accelerated in a manner in which the shear forces of the gas strip at least some of the solvent buffer from the cells or particles, after which the solvent-stripped cells are transported for subsequent elemental analysis.

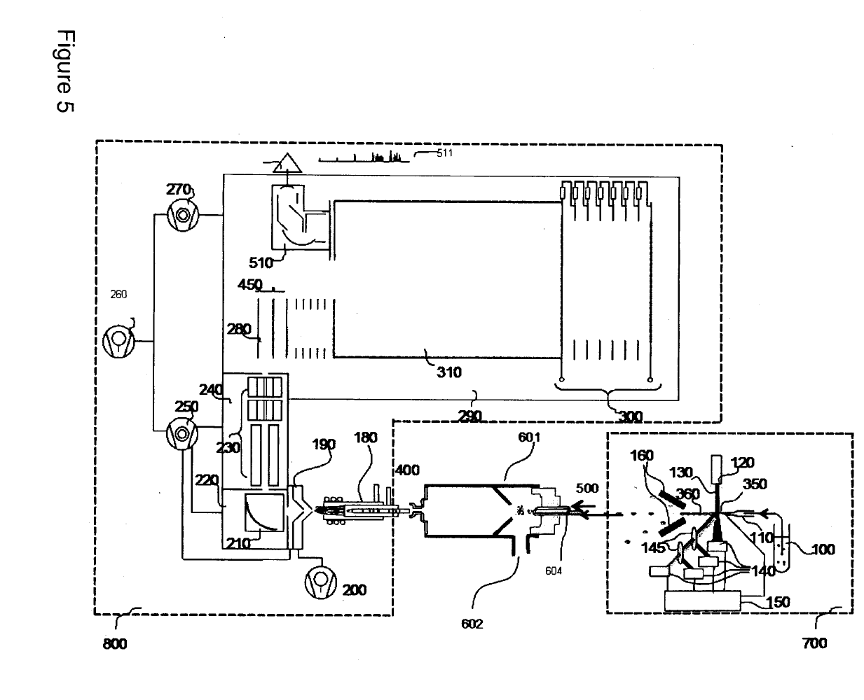

In further embodiments, droplets that may contain cells or particles in flow cytometry or of nebulization, and pre-selected using the flow through reversed spray chamber in the manner described in FIG. 5. The reversed spray chamber 601 according to the present invention is shown acting as an interface between the flow apparatus 700 and atomic spectrometry apparatus 800. The reversed spray chamber 601 that serves the specified purposes of the separation of associated cells or particles, removal of the solvent and small particles, may be achieved in combination with other flow apparatus and atomic spectrometry apparatus not described herein, but such embodiments are included within the scope of the invention. Small droplets, particles and condensed solvent vapors are pumped through 602 to waste.

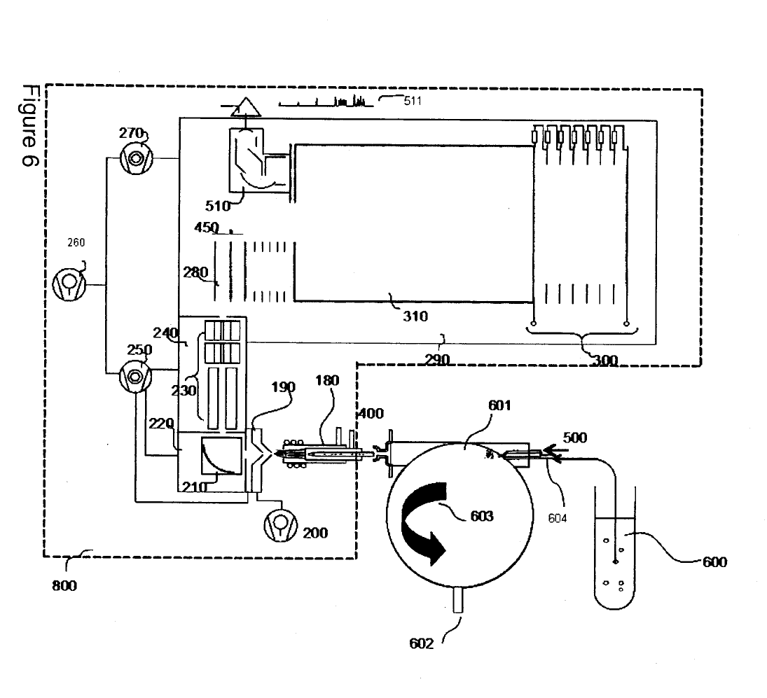

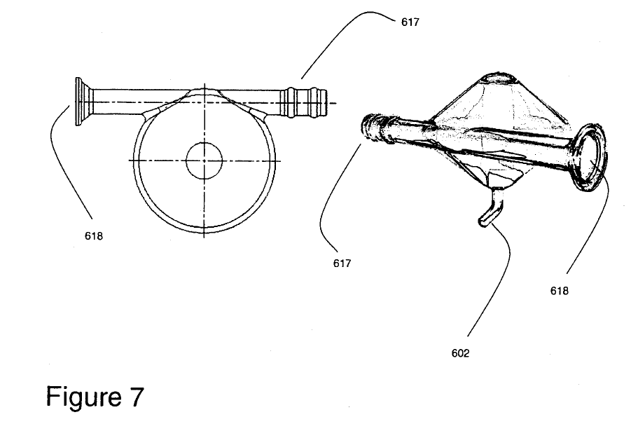

Various configurations of the reversed spray chambers can be demonstrated. One configuration which is specifically designed/invented for the present flow cytometry application is shown in FIG. 6. In the embodiment shown in FIG. 6, a sample is introduced by pneumatic nebulization, though other manners of introduction are known in the art (e.g., laser ablation particulate injection and direct particulate injection). The sample 600, which is usually a liquid but may also be slurry, is introduced via a pneumatic nebulizer 604 together with a nebulization gas 500, by which the liquid sample is converted to an aerosol. In this embodiment, the aerosol is size-separated in the reversed cyclonic spray chamber 601 so that, for example, particles having larger diameters (typically between 1 and 50 microns) can be passed further into the ICP torch 180 while smaller aerosol particles are dragged in cyclonic motion 603 by whirl of gas and diverted to another destination, such as waste 602. There are many variations of spray chambers known in the art which can be reversed for this purpose; one embodiment is demonstrated in FIG. 7 with inlet 617 that connects to a nebulizer and outlet 618 and that connects to the plasma torch 180. The reversed spray chamber 601 according to an embodiment of the present invention is shown acting as an interface between the sample introduction apparatus 600 and atomic spectrometry apparatus 800.

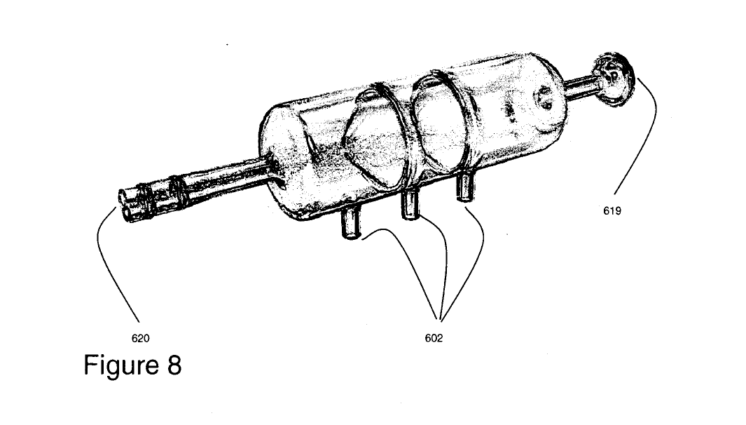

In yet another embodiment the schematic representation of the flow through reversed spray chamber is presented in FIG. 8 with inlet 620 that connects to a nebulizer, outlet 619 that connects to the plasma torch 180, and drainage to remove waste 602 separately from every sub-chamber.

In an example to demonstrate utility of the invention, beads with NH2 surface groups (Amine PS 1.8 micro m Beads PA04N/7603, Bangs Laboratories Inc., Fishers, Ind.) were modified by conjugation to anhydrous DTPA. The beads were washed several times and re-suspended in carbonate-bicarbonate buffer pH 9.6.

An aliquot of stock bead preparation (10 micro l) was added to 1 ml of 10 mM ammonium acetate buffer, pH 7.2. Solutions of Tm and Ho hydrochlorides (0.6 ppm) were prepared in the same buffer. 0.5 ml of bead suspension was quickly infused into 0.5 ml lanthanide solution and incubated at least 1 h at room temperature. Finally, the beads were washed in 100 KDa MWCO centrifugation filter devices (Pall Life Sciences, Ann Arbor, Mich.) with 5 volumes of buffer and re-suspended in ammonium acetate buffer at 300 000 beads/ml.

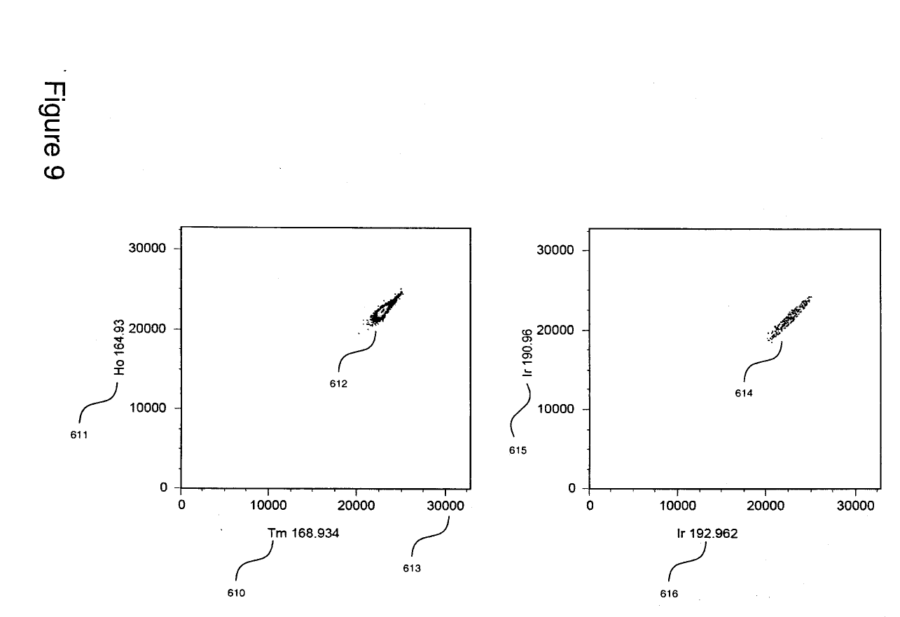

Experimental results of injection of 1.8 micro m polystyrene beads doped with metals employing the reversed spray chamber 601 (see e.g. FIGS. 5,8) according to the invention are presented in FIG. 9. Beads were doped with Tm 610 and Ho 611 and results are presented as two dimensional projection of signals 613 and 611 produced by every bead 612 registered by detector 510.

In a further example demonstration of the utility of the invention, KG1a cells, human leukemia cell line, were collected from suspension culture, centrifuged at 300×g for 5 min, washed with PBS and fixed in 2% formaldehyde. The cells were kept at 4° C. in fixative.

Aliquots of fixed cells were stained with Ir-intercalator^{14;15} at concentrations 0.01 micro M for 30 min at room temperature. Washed cells were re-suspended in ammonium bicarbonate buffer, pH 7.2, at 300 000, 1 000 000 and 3 000 000 per 1 ml.

Experimental results of injection of KG1a cells stained with Ir-intercalator employing the reversed spray chamber 601 according to the invention are presented in FIGS. 5,8. KG1a cells stained with Ir-intercalator having two natural isotopes ¹⁹¹Ir 615 and ¹⁹³Ir 616 and results are presented as two dimensional projection of signals produced by every cell 614 registered by detector 510.

The methods and apparatus described herein tend to be advantageously used when the cell sample is contained in a solvent having a high vapour pressure (for example, such as methanol, ethanol or DMSO), or in supercritical fluids (for example, such as supercritical carbon dioxide).

While the foregoing invention has been described in some detail for purposes of clarity and understanding, it will be appreciated by those skilled in the relevant arts, once they have been made familiar with this disclosure, that various changes in form and detail can be made without departing from the true scope of the invention in the appended claims. The invention is therefore not to be limited to the exact components or details of methodology or construction set forth above. Except to the extent necessary or inherent in the processes themselves, no particular order to steps or stages of methods or processes described in this disclosure, including the Figures, is intended or implied. In many cases the order of process steps may be varied without changing the purpose, effect, or import of the methods described.

The following references are referred to in this application, which references are hereby incorporated by reference:
1. Bandura, D. R., Baranov, V., I, and Tanner, S. Elemental flow cytometer, e.g. mass spectrometer or optical emission spectrometer based cytometer used in, e.g. health science, food sciences, environmental sciences, and genomics and proteomics, has spectrometer. Bandura, D. R., Baranov, V., I, Tanner, S., and MDS INC. [US2005218319-A1; WO2005093784-A1]. 2006.
2. Baranov, V., Tanner, S., Bandura, D., and Quinn, Z. Kit for detecting/measuring transition element, comprising tag having transition element for tagging biologically active material and instruction for tagging material, combining tagged material with analyte, detecting/measuring elements. MDS SCIEX and MDS INC. [US2004072250-A1; WO2005003767-A2]. 2006.
3. Gonzalez, J. J.; Liu, C. Y.; Wen, S. B.; Mao, X. L.; Russo, R. E. Talanta 2007, 73, 567-76.
4. Olesik, J. W.; Fister, J. C. Spectrochimica Acta Part B-Atomic Spectroscopy 1991, 46, 851-68.
5. Hobbs, S. E.; Olesik, J. W. Analytical Chemistry 1992, 64, 274-83.
6. Jorabchi, K.; Kahen, K.; Gray, C.; Montaser, A. Analytical Chemistry 2005, 77, 1253-60.
7. Olesik, J. W.; Smith, L. J.; Williamsen, E. J. Analytical Chemistry 1989, 61, 2002-08.
8. Gikunju, C. M.; Lev, S. M.; Birenzvige, A.; Schaefer, D. M. Talanta 2004, 62, 741-44.
9. Li, F. M.; Armstrong, D. W.; Houk, R. S. Analytical Chemistry 2005, 77, 1407-13.
10. Nomizu, T.; Kaneco, S.; Tanaka, T.; Ito, D.; Kawaguchi, H.; Vallee, B. T. Analytical Chemistry 1994, 66, 3000-04.
11. Nomizu, T.; Hayashi, H.; Hoshino, N.; Tanaka, T.; Kawaguchi, H.; Kitagawa, K.; Kaneco, S. Journal of Analytical Atomic Spectrometry 2002, 17, 592-95.
12. Zhang, B.; Li, F. M.; Houk, R. S.; Armstrong, D. W. Analytical Chemistry 2003, 75, 6901-05.
13. Houk, R. S.; Fassel, V. A.; Flesch, G. D.; Svec, H. J.; Gray, A. L.; Taylor, C. E. Analytical Chemistry 1980, 52, 2283-89.
14. Schafer, S.; Sheldrick, W. S. Journal of Organometallic Chemistry 2007, 692, 1300-09.
15. Scharwitz, M.; Schafer, S.; van Almsick, T.; Sheldrick, W. S. Acta Crystallographica Section E-Structure Reports Online 2007, 63, M1111-M1113.

What is claimed is:

1. A flow cytometer instrument, comprising a cell injector for receiving particles from a sample slurry of particles associated with a biological material, the cell injector transforming the sample slurry of the particles into a form suitable for ionization and transmitting the transformed particles for injection into a mass spectrometer detector for the analysis of the individual particle, the spectrometer having:
a plasma torch having a center tube being connected to the cell injector to receive the particles;
a radio frequency power source and a load coil coupled to the plasma torch to generate and maintain a plasma in the plasma torch for ionizing the received particles;
a mass detector disposed downstream of the plasma torch for receiving ionized particles from the plasma torch and operative for detecting the particles in the sample slurry.

2. The flow cytometer instrument of claim 1, further comprising an optical flow sorter connected upstream of the cell injector.

3. A flow cytometer instrument for the analysis of individual particles in a sample slurry of particles associated with a biological material, the instrument comprising:
an optical flow sorter receiving particles of the sample slurry;
a cell injector connected to an outlet of the optical flow sorter to select particles from the slurry;
a plasma torch having a center tube being connected to the cell injector to receive the particles;
a radio frequency power source and a load coil coupled to the plasma torch for generating and maintain a plasma in the torch capable of ionizing the particles;
a mass detector disposed downstream of the plasma torch for receiving the ionized particles from the plasma torch and operative for detecting individual particles in the sample slurry.

4. The flow cytometer instrument of any one of claim 2 or 3, wherein:
the sample slurry includes at least one of a solvent or buffer solution;
the flow sorter receives droplets containing the particles from the sample slurry and transports the droplets through an aperture into a high-speed gas stream, through which an amount of the at least one of the solvent or buffer solution is stripped from the droplets containing the particles, and such particles are provided to the plasma torch for vaporization, atomization and ionization.

5. The flow cytometer instrument of claim 4 wherein the high-speed gas stream is a high-speed argon gas stream.

6. The flow cytometer instrument of any one of claim 2, 3 or 4, further comprising a nebulizer connected to the sorter, the nebulizer producing the droplets containing the particles in a spray in the form of a mist, wherein the droplets are smaller than those produced by the flow sorter, for injection into the plasma torch.

7. The flow cytometer instrument of claim 6, wherein the nebulizer includes an outlet connected to a reversed spray chamber disposed for receiving the spray, the spray chamber operative to classify the droplets of particles in the spray according to their momenta.

8. The flow cytometer instrument of claim 7, wherein the spray chamber selectively transmits droplets containing the particles to the plasma torch on the basis of their momenta.

9. The flow cytometer instrument of claim 4, wherein the droplets containing the particles are subjected to interrogation and spatial sorting by the optical flow sorter, and droplets containing the particles of interest as determined by at least one analytical characteristic are spatially separated from other droplets.

10. The flow cytometer instrument of either of claim 6 or 7, wherein the nebulizer operates by pneumatic nebulization of the sample slurry for producing the droplets containing particles.

11. The flow cytometer instrument of claim 10, wherein the pneumatic nebulization includes providing a nebulizing gas flow utilizing at least one of coaxial continuous nebulization, cross-flow continuous nebulization, cross-flow pulsed nebulization, coaxial pulsed nebulization, and flow-focusing pneumatic nebulization.

12. The flow cytometer instrument of any one of claim 4 or 6, wherein the flow sorter further comprises a charger for charging at least a portion of the droplets containing the particles and a deflector for deflecting the portion of charged droplets containing the particles, wherein the charging and deflecting is controlled according to a classification provided by the sorter based on at least one analytical characteristic.

13. The flow cytometer instrument of claim 12, wherein the classification determines the portion of the droplets that relate to unwanted spray components, so that the charger charges such unwanted spray components and the deflector deflects such components away from entry to the cell injector.

14. The flow cytometer instrument of claim 11, wherein the operation conditions of the nebulizer is variable by changing an input flow rate of the sample slurry and a flow rate of the nebulizing gas, whereby droplet size and droplet size distribution of the resultant spray of sample slurry is affected.

15. The flow cytometer instrument of any one of claim 4-9, 12 or 13, wherein the nebulizer converts the sample slurry to the droplets by at least one of pneumatic, spinning-disk, and ultrasonic agitation operation.

16. The flow cytometer instrument of any one of claims 4-15, further comprising an aperture through which the nebulizing gas is accelerated in a manner in which shear forces of the nebulizing gas strip at least some of the buffer solution from the particles.

17. The flow cytometer instrument of any one of claims 4-16, wherein the aperture is a critical flow orifice through which the nebulizing gas is accelerated to supersonic velocity.

18. The flow cytometer instrument of any one of claims 6-8, 10-14 and 17, further comprising a desolvator to desolvate the spray of the sample slurry by way of at least one of a thermal device or a solvent-permeable membrane.

19. The flow cytometer instrument of any of one of claim 9 or 12, wherein the analytical characteristic includes at least one of light scattering or stimulated fluorescent emission.

20. The flow cytometer instrument of any one of claim 4, 9, 12, or 13, wherein the flow sorter is connected to the cell injector by a capillary tube.

21. A method of analyzing particles in a sample slurry associated with a biological material using a flow cytometer instrument with a mass spectrometer detector, the method comprising:
nebulizing the sample slurry to produce a spray in the form of a mist, the spray having droplets at least some of which contain particles from the sample slurry;
classifying the droplets in the spray by spatially separating the droplets according to their momenta;
introducing a selected portion of the classified droplets into a plasma torch of the instrument to ionize the droplets;
detecting at least one element that was at least one of contained within or on the particles that were in the droplets.

22. The method of claim 21, wherein the sample slurry includes a solvent or buffer solution, and prior to introducing the classified droplets into the plasma torch, at least a portion of the solvent of buffer solution is separated from the droplets of particles, whereby the droplets are introduced into the plasma torch with a concomitantly reduced solvent or buffer solution load.

23. The method of claims 21-22, wherein the spray is produced at a sample slurry flow rate that extends from approximately 1 micro l/min to 1000 micro l/min.

24. The flow cytometer instrument of any one of claims 6, 7, 10 and 11, wherein the spray is produced at a sample slurry flow rate that extends from approximately 1 micro l/min to 1000 micro l/min.

25. The flow cytometer instrument of claim 14, wherein the nebulizing gas flow rate is between 0.1 liters/min. and 1.5 liters/min.

26. The flow cytometer instrument of any one of claims 1-20, 24 and 25, wherein the particles are at least one of cells, bacteria, viruses, pollen, chromosomes, or particles associated with biological molecules, including proteins or oligonucleotides.

27. The method of any one of claims 21-23, wherein the particles are at least one of cells, bacteria, viruses, pollen, chromosomes, or particles associated with biological molecules, including proteins or oligonucleotides.

28. The flow cytometer instrument of any one of claim 4 or 9, wherein the at least one of a solvent or a buffer solution includes at least one of a high vapor pressure fluid or a supercritical fluid.

29. The flow cytometer instrument of claim 28, wherein the high vapor pressure fluid includes at least one of methanol or ethanol.

30. The method of claim 22, wherein the at least one of the solvent or buffer solution includes at least one of a high vapor pressure fluid or a supercritical fluid.

31. The method of claim 30, wherein the high vapor pressure fluid includes at least one of methanol or ethanol.
